(19) United States
(12) Patent Application Publication
(10) Pub. No.: US 2014/0216270 A1
(43) Pub. Date: Aug. 7, 2014

(54) Food Skewer Device

(71) Applicant: James Robert Campbell, Helena, MT (US)

(72) Inventor: James Robert Campbell, Helena, MT (US)

(21) Appl. No.: 13/758,825

(22) Filed: Feb. 4, 2013

(51) Int. Cl. A47J 37/07

(52) U.S. Cl. CPC A47J 37/0786
USPC 99/419

(57) ABSTRACT

The invention is directed to an improved combination barbecue grilling means and warming rack, comprising a food skewer device having at least one metal skewer, said warming rack having a plurality of parallel horizontal rods, said parallel rods having a forward-most rod and being modified to provide an additional horizontal rod extending parallel to said horizontal rods and disposed slightly below the forward-most rod, for receiving said metal skewer. Said metal skewer is laterally and fixedly inserted between the forward-most rod and the additional horizontal rod. In another embodiment, a metal skewer is bent to form a right angle offset to hold foods above a barbecue grilling means. The offset metal skewer fits at right angles between said rods of a barbeque warming rack. Another embodiment uses a continuous wire or multiple wire construction formed into a table top to hold said skewers

### FIELD OF THE INVENTION

The present invention relates to a food skewer device, used as a food support, for barbecuing food on a combination barbecue grill and warming rack and modifying the conventional barbecuing devices known in the industry.

### BACKGROUND OF THE INVENTION

This invention is a device to barbecue food on a skewer while being suspended over a barbecue grilling means, such as a gas or barbecue gill. One end of the skewer is inserted into a barbecue warming rack. The other end is left to hover above the grill. A plurality of food items such as poultry wings and legs, and meat ribs, vegetables and kabobs are cooked without the need to be turned. There is no barbecue apparatus to clean or store.

Chicken wings and chicken legs pierced near their out joint hang in a vertical position on the skewer. Kabobs or vegetables cook horizontally above the grilling means. The skewer is inserted transverse, at approximately right angles, between the top and bottom front rods of a warming rack designed to hold such skewers. At least one food item, as mentioned above, is pierced by the skewer and hung over the grill surface to be barbecued by the present invention. A warming rack designed to hold skewers can be an independent warming rack or a warming rack incorporated into a gas or briquet barbecue grill or other grilling means. There is no need to ever turn the food being cooked using a warming rack designed to hold skewers.

The problem of storing and cleaning a barbecue grilling apparatus is eliminated. It is solved by using only a skewer to suspend food items such as chicken wings, chicken legs, or kabobs above a grilling means, such as a gas/barbecue grill. No trays or racks need to be washed or stored.

A traditional barbecue warming rack generally has horizontal rods equally spaced apart and run across the back of a barbecue, above the barbecue grilling means. The present invention adds one additional horizontal rod below the front rod. A metal skewer is inserted between the two fronting rods at right angles. The bottom surface of the skewer rests on the additionall, lower rod and the top surface of the skewer rests on or impinges against the bottom surface of the second and third rod. The hovering portion of the skewer holding the food items above the barbecue grilling means.

Certain related art patent references disclose various types of barbecuing devices utilizing a metal skewer for grilling, having a sharpened end and a handle end; for example, U.S. Pat. No. 7,340,993 to Sculuca “'993 Patent”), U.S. Pat. No. 7,281,469 to Barbour et al (“'469 Patent”, U.S. Pat. No. D512,884 to Wall (“'884 Patent”), and U.S. Pat. No. 5,730,046 to Battaglia (“046 Patent”). Various metal barbecue grill racks in related art are provided to support metal skewers over a barbecue grill or open flame. Patent '993 discloses a support means including holes for receiving the metal skewers, a pair of raised parallel abutments onto which the skewers are laid and insertion of metal skewers through expanded steel. Patent '469 discloses a self-supporting wire rack adapted to overlying a grill and receive skewers, however not in a direction transverse to the rack. None of the related art discloses modifying a warming rack of a conventional barbecue grill in combination therewith in the manner set forth in the present invention.

Patent '993, Patent '469, and Patent '046 disclose the use of various self-supporting racks for suspending metal skewers over a barbecue grill. Patent '469, among others, discloses a wire table for supporting metal skewers by overlying them on the rack. However, none of the related art references disclose or suggest a warming rack or a self-supporting rack or table having the proposed additional parallel bar placed below the forward-most bar or rod of the warming rack to receive a metal skewer in a direction transverse to the warming rack. While Patent '046 provides a barbecue grill and warming rack combination, the cited reference does not provide for the use of metal skewers as well as the additional parallel bar as in the present invention.

As well, the '884 Patent, while providing an ornamental design of a wiener cooking device having skewers, it does not have or teach the feature of another embodiment of the present invention, that of a skewer having an offset, or “kink” along its length, proximal to its point end to allow the skewer to be supportedly located within the grill rods.

None of the cited devices herein disclose modifying a warming rack of a conventional barbecue grill in the manner set forth in the present invention. Therefore, as noted, none of the references contain every feature of the present invention, and none of these references in combination disclose or teach every feature of the present invention.

The foregoing and other objectives, advantages, aspects, and features of the present invention will be more fully understood and appreciated by those skilled in the art upon consideration of the detailed description of a preferred embodiment, presented below in conjunction with the accompanying drawings.

### SUMMARY OF THE INVENTION

The invention is directed to an improved combination barbecue grilling means and warming rack. One embodiment of the present invention is a food skewer device comprising at least one metal skewer which comprises a skewer rod having a sharpened point at a point end and a handle at an opposite handle end. The food skewer device further comprises a combination barbecue grilling means and warming rack, said warming rack having a plurality of parallel horizontal rods, and modified to provide an additional horizontal rod extending parallel to the plurality of parallel horizontal rods and disposed slightly below a forward-most rod of said warming rack, for receiving said metal skewer.

The at least one metal skewer is cantileveredly suspended perpendicularly and horizontally away from the means and warming rack. The point end of said metal skewer is laterally and fixedly inserted between the forward-most rod and the additional horizontal rod of said warming rack. The at least one metal skewer is supportedly located above the grill surface of the barbecue grilling means and transverse to the warming rack.

In one embodiment of the present invention, the additional horizontal rod is disposed slightly forward and below the forward-most rod of said warming rack. In other embodiments, the additional horizontal road may be disposed rearward of the forward-most rod.

In another embodiment, a metal skewer is bent or offset at right angles to form a right angle offset to the skewer, or an “S” curve or kink, to hold a plurality of foods above a barbecue grilling means. The skewer fits at right angles between said parallel rods, such as the first and second rods, of a barbeque warming rack. The handle end of this offset skewer hovers above the barbecue grilling means to cook pierced food without turning, as in the first embodiment discussed above.

An advantage of the present invention is that only the skewers need to be washed and stored. There are no racks or trays that need to be washed or stored. At this time there are no barbecue accessories that suspend food over a barbecue grill or other grilling means on a skewer anchored at one end off a barbecue warming rack.

In another embodiment of the present invention, an objective is to provide cooking food such as poultry and other foods noted above where the food does not need to be turned, by using a continuous wire or multiple wire construction, formed into a circle, square, or a rectangle, etc. That wire serves as a table top to hold skewers. The top is held up by a supporting configuration, which may be a leg frame above the barbecue grilling means. The leg frame may fold for compact shipping and storage.

The aforementioned features, objectives, aspects and advantages of the present invention, and further objectives and advantages of the invention, will become apparent from a consideration of the drawings and ensuing description.

### BRIEF DESCRIPTION OF THE SEVERAL VIEWS OF THE DRAWINGS

The foregoing features and other aspects of the present invention are explained and other features and objects of the present invention will become apparent in the following detailed descriptions, taken in conjunction with the accompanying drawings. However, the drawings are provided for purposes of illustration only, and are not intended as a definition of the limits of the invention.

FIG. 1 illustrates a side elevation view of one embodiment of the present invention, comprising a combination barbecue grilling means and warming rack, having an at least one metal skewer.

FIG. 2 illustrates an elevation view of the at least one metal skewer in one embodiment of the present invention.

FIG. 3 illustrates a side view of an at least one offset metal skewer in one embodiment of the present invention.

FIG. 4 illustrates a partial plane view of the at least one metal skewer to one embodiment of the present invention inserted into a plurality of horizontal rods of the warming rack.

FIG. 5 illustrates a partial side view of the at least one metal skewer inserted into the plurality of horizontal rods to one embodiment of the present invention.

FIG. 6 illustrates a partial plane view of the at least one offset metal skewer inserted into the plurality of horizontal rods of the warming rack, in another embodiment of the present invention.

FIG. 7 illustrates a side elevation view of one embodiment of the present invention, comprising a combination barbecue grilling means and warming rack, having the at least one offset metal skewer.

FIG. 8 illustrates a perspective view of another embodiment of the present invention depicting a self-supporting wire table.

### DETAILED DESCRIPTION OF THE INVENTION

The present invention will now be described more fully hereinafter with references to the accompanying drawings, in which the preferred embodiment of the invention is shown. This invention may, however, be embodied in different forms, and should not be construed as limited to the embodiments set forth herein. Rather, the illustrative embodiments are provided so that this disclosure will be thorough and complete, and will fully convey the scope of the invention to those skilled in the art. It should be noted, and will be appreciated, that numerous variations may be made within the scope of this invention without departing from the principle of this invention and without sacrificing its chief advantages. Like numbers refer to like elements throughout.

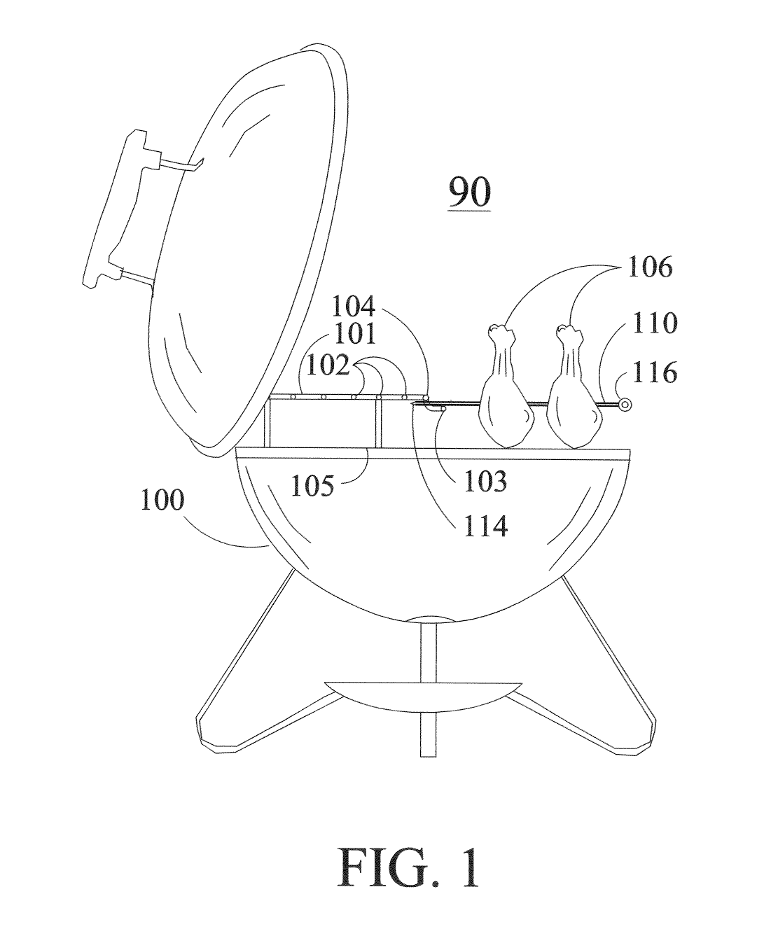

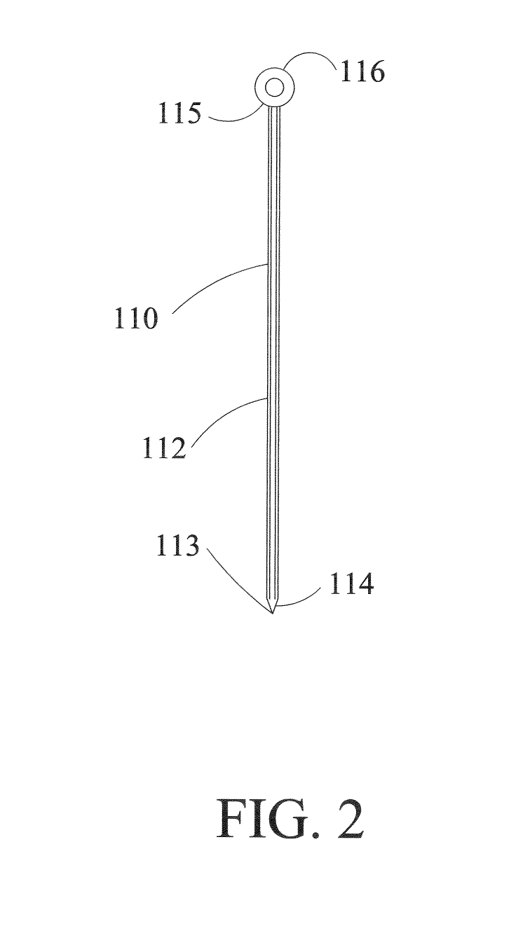

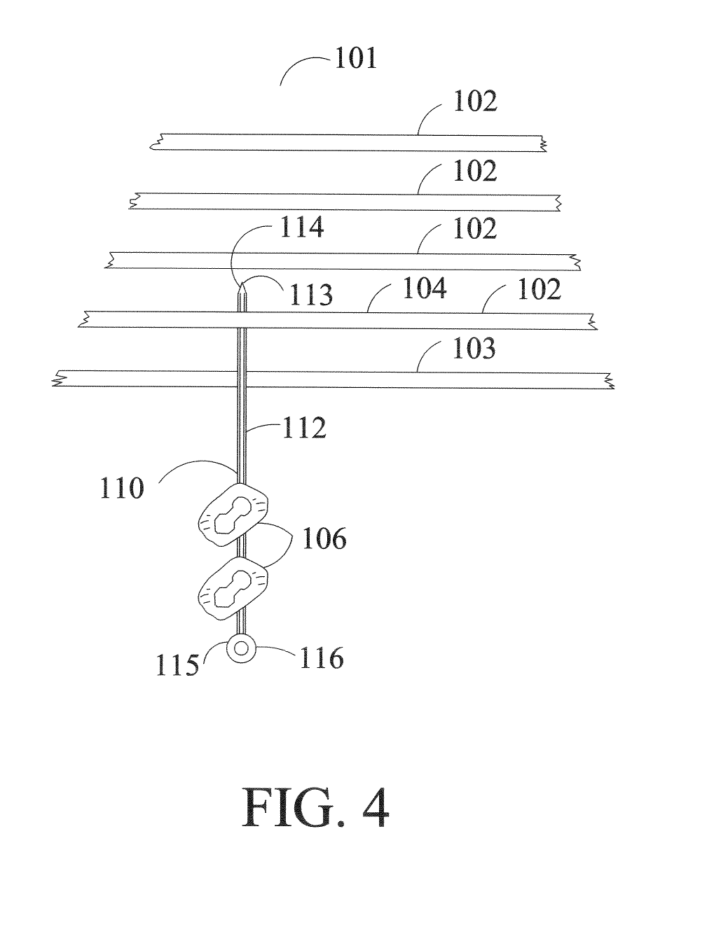

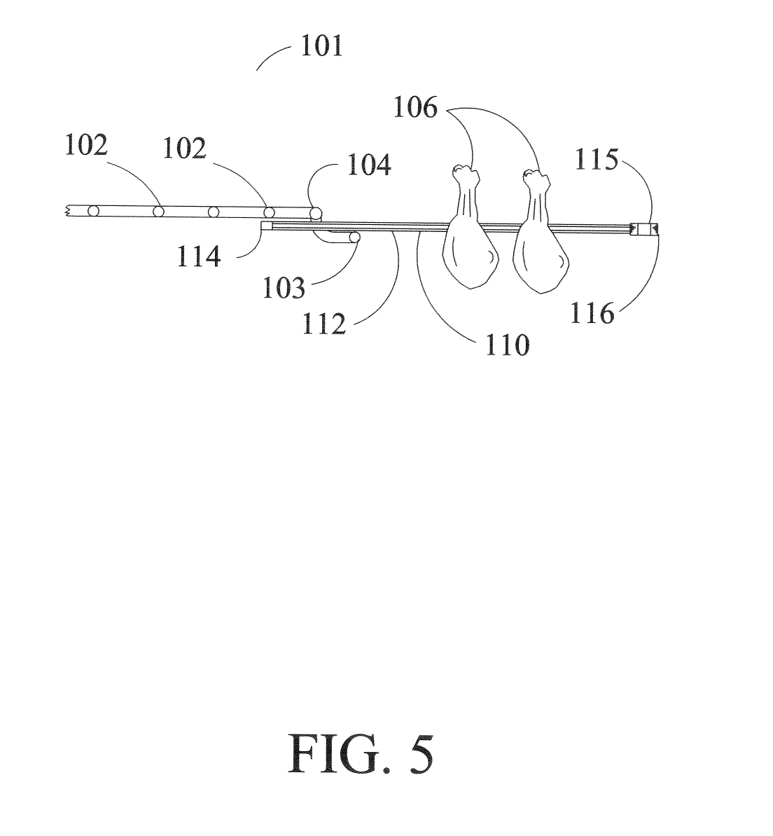

Turning now in detail to the drawings in accordance with the present invention, one embodiment of the present invention is depicted in FIG. 1 of a food skewer device 90 comprising at least one metal skewer 110, which further comprises a skewer rod 112 having a sharpened point 113 at a point end 114 and a handle 115 at an opposite handle end 116, as more particularly disclosed in FIG. 2. The food skewer device 90 further comprises a combination barbecue grilling means 100 and warming rack 101, said warming rack 101 having a plurality of parallel horizontal rods 102 having a forward-most rod 104 and being located above a grill surface 105 to said grilling means 100, also depicted in FIGS. 4 and 5. The warming rack 101 shown in FIG. 1 is modified to provide an additional horizontal rod 103 extending parallel to the plurality of parallel horizontal rods 102 and disposed slightly forward and below the forward-most rod 104 of said warming rack 101, for receiving said metal skewer 110. In alternative embodiments of the present invention, the additional horizontal rod 103 may be disposed immediately below or below and behind the forward-most rod 104.

The food skewer device 90 is constructed of firm, resilient metal commonly used in this industry for combination barbecue grills and warming racks. The barbecue grilling means 100 may be any form of cooking means known in the industry that involves dry heat applied to the surface of food, commonly from below, or above in broiling, such as barbecue cooking by a number of heating elements including gas, wood chips or briquets, on a grill, broiler or grill pan, open fire or griddle, with the heat transferring primarily through thermal radiation. The grilling means 100 may be portable, movable or stationary.

As shown in FIGS. 1 and 4, in an embodiment of the present invention, the at least one metal skewer 110 is cantileveredly suspended perpendicularly and horizontally away from the warming rack 101 and above the grilling means 100. The at least one metal skewer 110 is laterally and fixedly inserted at its point end 114 between the forward-most rod 104 and the additional horizontal rod 103 of said warming rack 101, and secured toward its point end 114. At least one food item 106 is pierced onto, or otherwise affixed to, said skewer 101, and hung from the at least one metal skewer 110 toward the handle end 116, over the grill surface 105, without the need for turning said food item 106 during cooking. FIGS. 1, 4 and 5, of this embodiment of the present invention, show the at least one metal skewer 110 as supportedly located above the grill surface 105 of the barbecue grilling means 100, transverse to the warming rack 101, of the food skewer device 90.

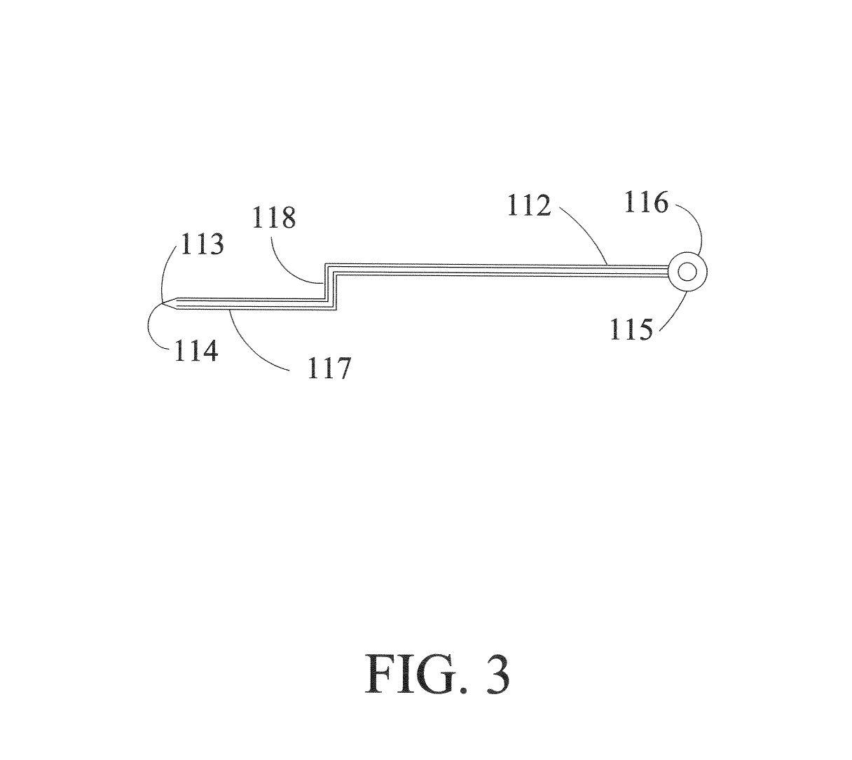

FIG. 3 partially discloses another embodiment of the food skewer device 90, said device 90, comprising an at least one offset metal skewer 117, the skewer rod 112 having a sharpened point 113 at its point end 114, a handle 115 at an opposite handle end 116 and a right angle offset 118 located proximal to the point end 114 along the skewer rod 112. The said offset metal skewer 117 is bent, or offset, at right angles to the skewer rod 112 to form the right angle offset 118 to said skewer rod 112, or an “S” curve or kink, to hold a plurality of food items 106, as heretofore described, above the barbecue grilling means 100.

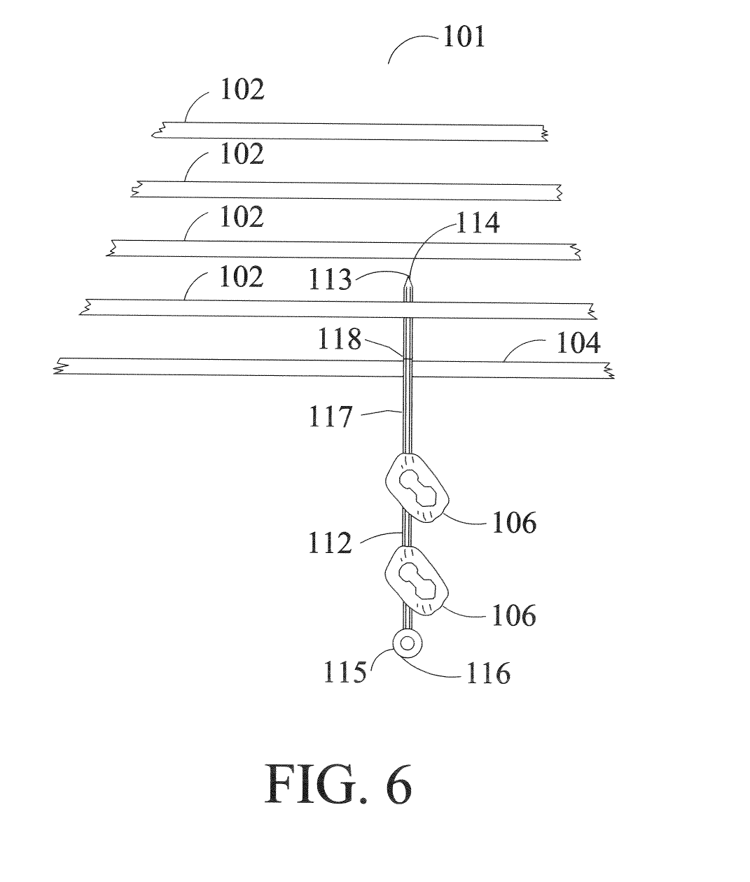

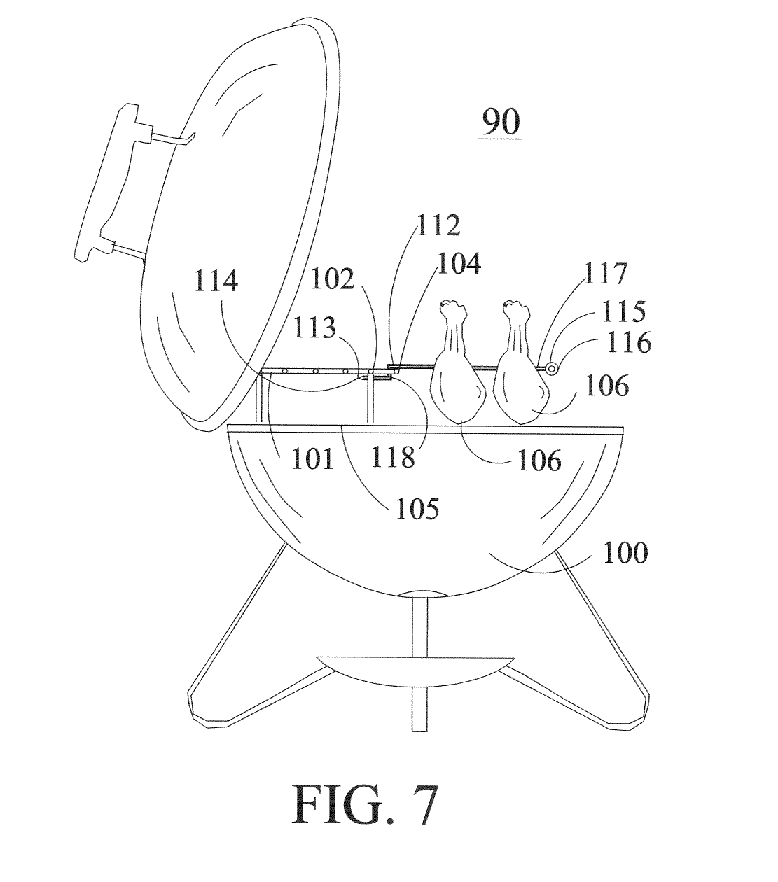

In this embodiment of the present invention, shown in FIGS. 6 and 7, having a combination barbecue grilling means 100 and warming rack 101, the warming rack 101 has a plurality of parallel horizontal rods 102 located above a grill surface 105, and the metal skewer rod 112 is cantileveredly suspended perpendicularly and horizontally away from the warming rack 101. As shown further in FIGS. 6 and 7, said offset metal skewer 117 is laterally and fixedly secured toward its point end 114 above the forward-most rod 104 and below the plurality of horizontal rods 102 to the warming rack 101 by the right angle offset 118. The at least one offset metal skewer 117 is supportedly located above the grill surface 105 of the barbecue grilling means 100 and transverse to the warming rack 101.

Said offset metal skewer 117 securely fits at its right angle offset 118 between the plurality of horizontal parallel rods 102 of the barbeque warming rack 101, as shown in FIGS. 6 and 7. The at least one food item 106 is pierced, or otherwise affixed, onto and hung from the at least one offset metal skewer 117 toward the handle end 116, over the grill surface 105. The handle end 116 of said offset metal skewer 117 hovers above the barbecue grilling means 100, shown in FIG. 7, to cook the pierced at least one food item 106 without the need for turning said food item 106 during cooking.

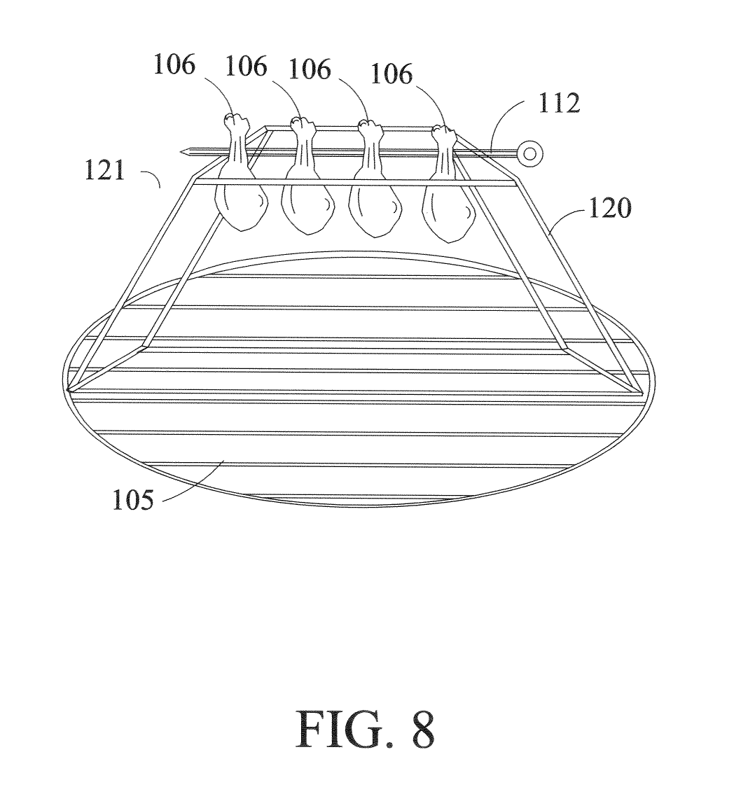

In another embodiment of the present invention, FIG. 8 shows the food skewer device 90, where the combination barbecue grilling means 100 and warming rack 101 further compromises the warming rack 101 having a self-supporting wire table 120 having a supporting configuration 121 in which the at least one metal skewer 110, having at least one food item 106, is laid and positioned above the grill surface 105 of the barbecue grilling means 100. The self-supporting wire table 120 serves a as a table top to hold the at least one metal skewer 110. Said wire table 120 is held up by the supporting configuration 121 above the barbecue grilling means 100. The supporting configuration 121 may be a leg frame or other similar support, in a stationary position or foldable for compact shipping and storage, and made of firm, resilient metal rods.

Having thus described in detail a preferred selection of embodiments of the present invention, it is to be appreciated, and will be apparent to those skilled in the art, that many physical changes could be made in the device without altering the invention, or the concepts and principles embodied therein. Unless otherwise specifically stated, the terms and expressions have been used herein as terms of description and not terms of limitation, and are not intended to exclude any equivalents of features shown and described or portions thereof. Various changes can, of course, be made to the preferred embodiment without departing from the spirit and scope of the present invention. The present invention device, therefore, should not be restricted, except in the following claims and their equivalents.

I claim:

1. A food skewer device, said device comprising:
(a) at least one metal skewer comprising a skewer rod having a sharpened point at a point end and a handle at an opposite handle end;
(b) a combination barbecue grilling means and warming rack, said warming rack having a plurality of parallel horizontal rods, said parallel rods having a forward-most rod, and said parallel horizontal rods being located above a grill surface of the grilling means;
(c) the warming rack being modified to provide an additional horizontal rod extending parallel to the plurality of parallel horizontal rods and disposed slightly below the forward-most rod of said warming rack, for receiving said metal skewer;
(d) said metal skewer being laterally and fixedly inserted between the forward-most rod and the additional horizontal rod of said warming rack, securing said metal skewer toward its point end;
(e) the at least one metal skewer being cantileveredly and perpendicularly suspended horizontally away from said warming rack and above said grilling means; and
(f) whereby said metal skewer is supportedly located above the grill surface of the barbecue grilling means and transverse to the warming rack, and at least one food item is pierced onto and hung from said metal skewer toward the handle end, over the grill surface.

2. The device of claim 1, wherein the additional horizontal rod is disposed slightly forward and below the forward-most rod of said warming rack.

3. the device of claim 1, wherein the combination barbecue grilling means and warming rack further compromises:
(a) the warming rack comprising a self-supporting wire table;
(b) said wire table having a supporting configuration whereon the at least one metal skewer having at least one food item laid and positioned on said wire table above the grill surface of the barbecue grilling means.

4. A food skewer device, said device comprising:
(a) at least one offset metal skewer comprising a skewer rod having a sharpened point at a point end, a handle at an opposite handle end and a right angle offset located proximal to the point end along the skewer rod;
(b) a combination barbecue grilling means and warming rack, said warming rack having a plurality of parallel horizontal rods, said parallel rods having a forward-most rod, and said parallel horizontal rods being located above a grill surface of the grilling means;
(c) the right angle offset allowing the at least one offset metal skewer to securely fit between said parallel horizontal rods;
(d) said offset metal skewer toward its point end being laterally and fixedly inserted above the forward-most rod and below the plurality of horizontal rods by the right angle offset;
the at least one offset metal skewer being cantileveredly perpendicularly suspended horizontally away from said warming rack; and
(f) whereby said offset metal skewer is supportedly located above the grill surface of said barbecue grilling means and transverse to said warming rack, and at least one food item is pierced onto and hung from said offset metal skewer toward the handle end, over the grill surface.
